(19) United States
(12) Patent Application Publication
(10) Pub. No.: US 2005/0188815 A1
(43) Pub. Date: Sep. 1, 2005

(54) RimRiser

(76) Inventor: James F. Shepherd, Woodside, NY (US)

Correspondence Address: James F. Sheperd, 51-27 63ST, Woodside, NY, 11377, US

(21) Appl. No.: 11/055,250

(22) Filed: May 16, 2005

Related U.S. Application Data
(60) Provisional application No. 60/544,830, filed on Feb. 17, 2004.

(51) Int. Cl. G10D 13/02; G03C 1/46

(52) U.S. Cl. 84/411 R

(57) ABSTRACT

My device is a rim extension for drummers. Previously drummers playing cross-stick (a player using the stick across the rim of the drum) there were hindrances due to the fact that a player would get a very limited grip on the stick, as well as a hard time finding a consistent sound throughout performances. The rim extensions allow a drummer almost 1 and ½ inches of free space, thus, improving stick handling and consistency making cross-stick playing much more effective and easier.

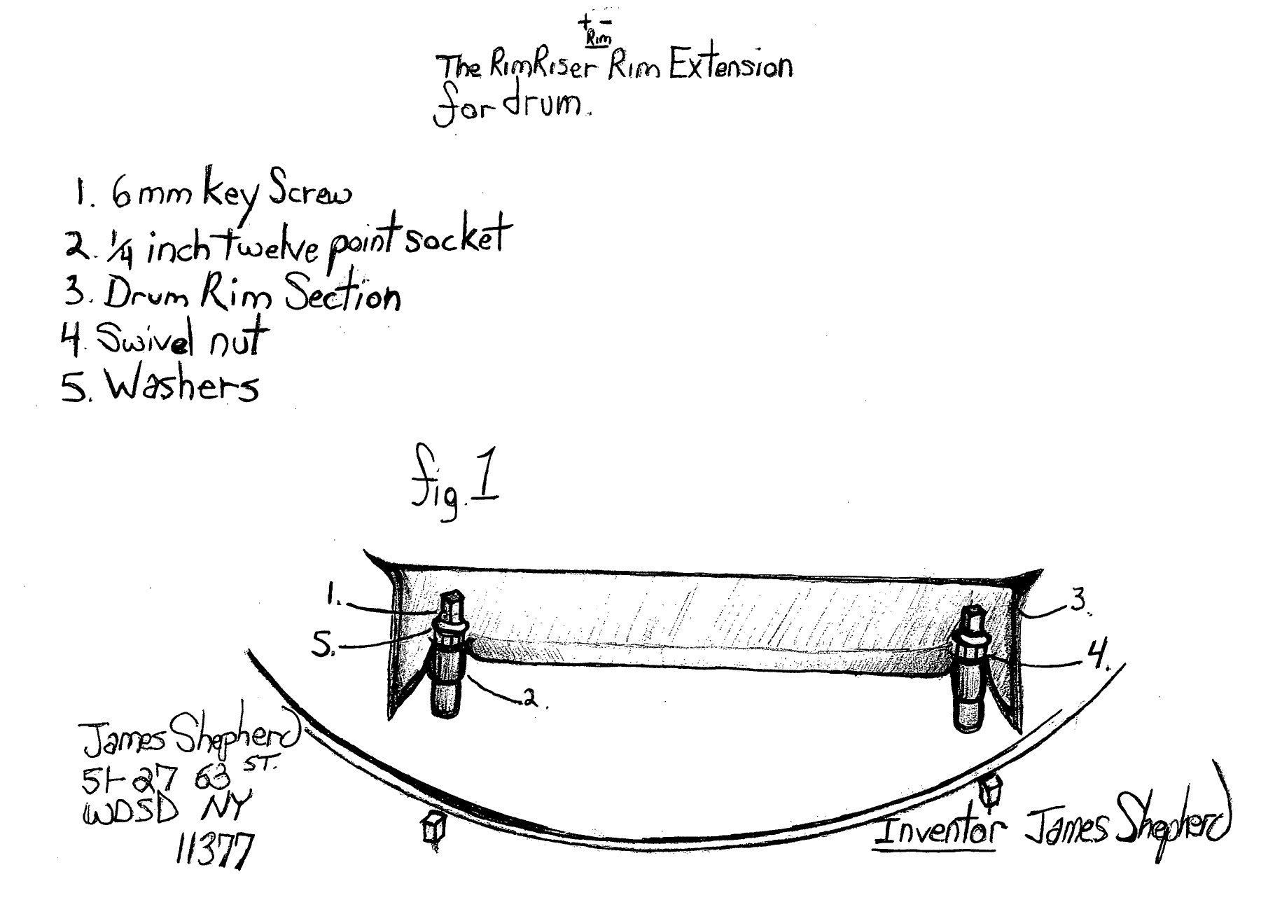

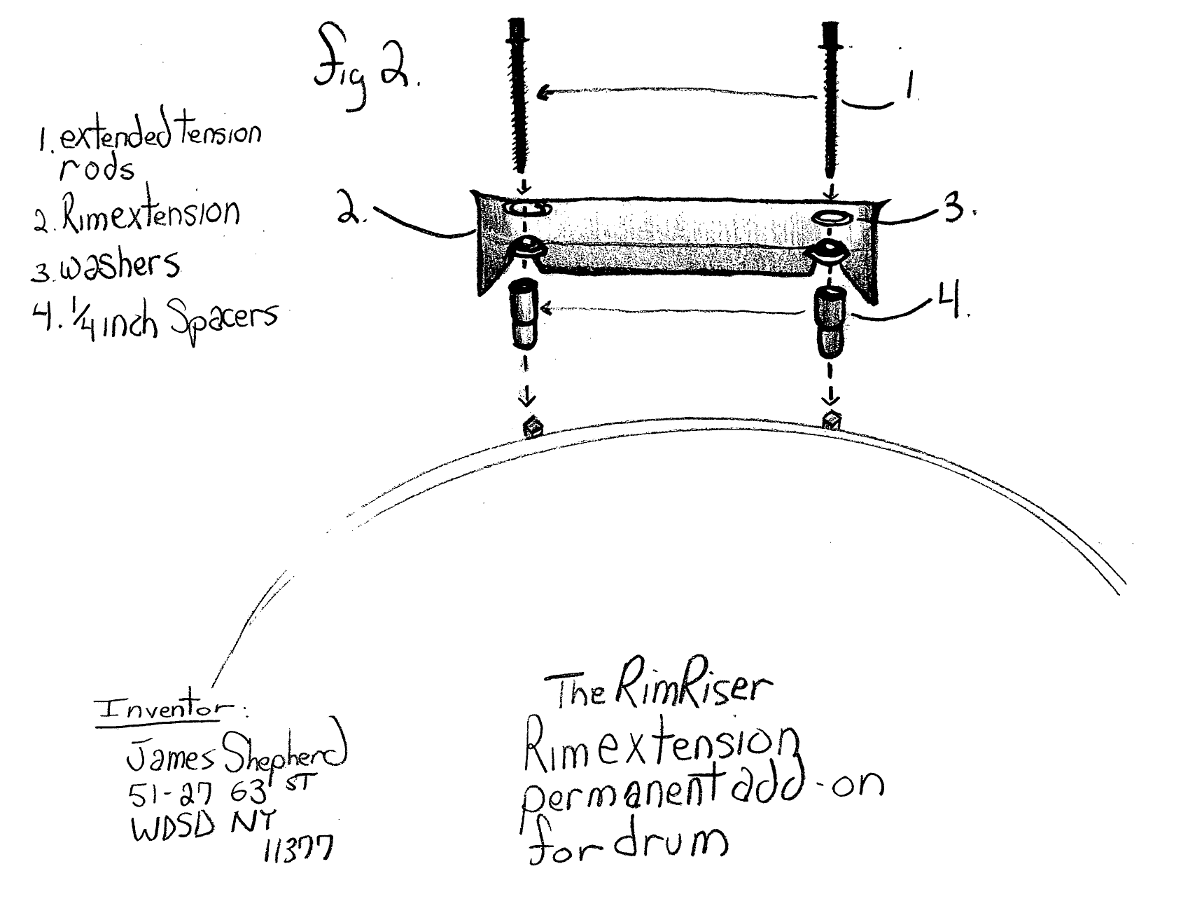

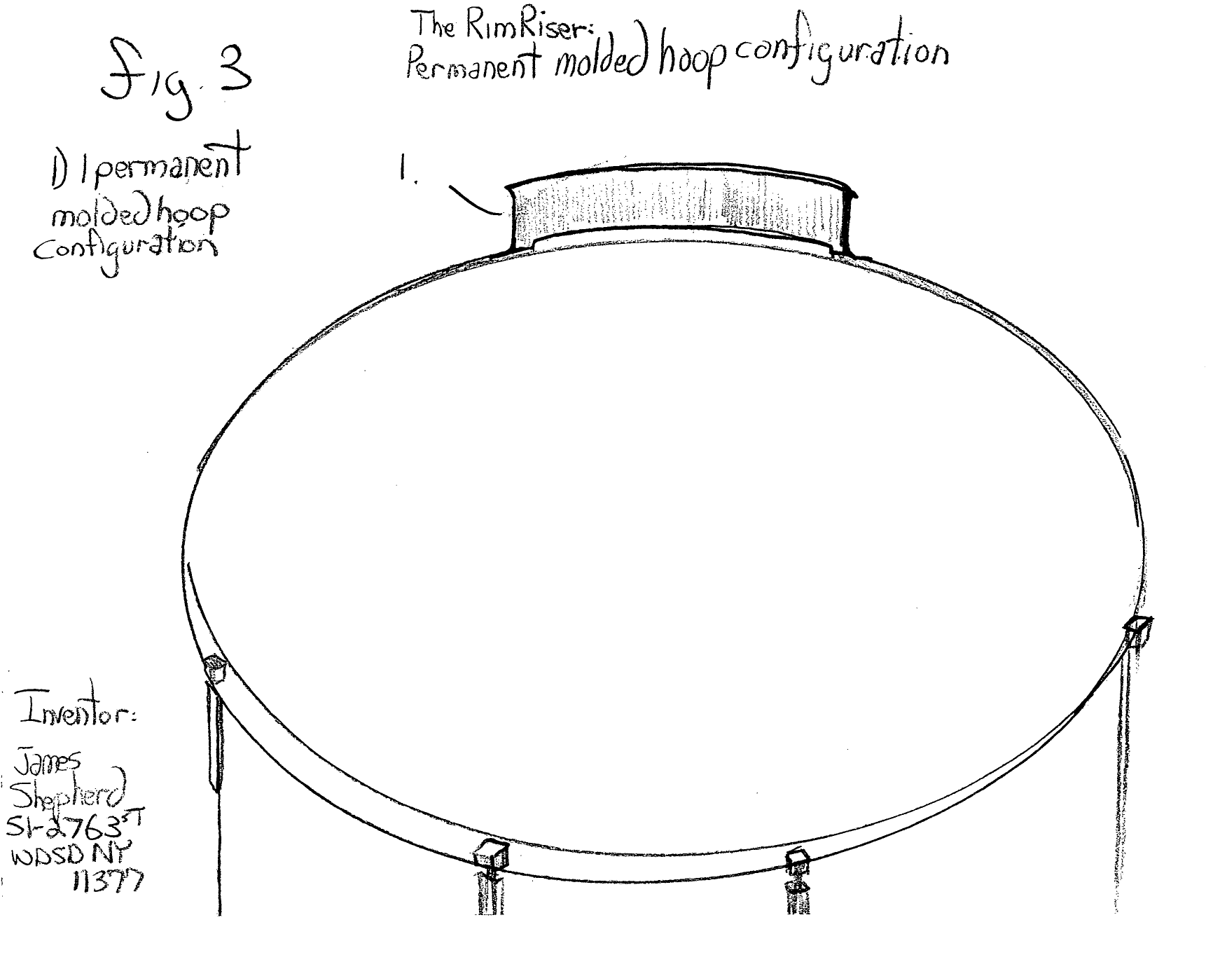

The invention is an apparatus that enhances cross-stick playing. It is a rim extension that is designed in three different ways.

1) One method is a steel section of rim with two twelve point sockets that attaches to existing drum rim by way of tightening the sockets onto the drum lugs with two 6 mm key screws screwing into swivel nuts fitted into the sockets.

2) The second method is a rim extension that is attached with extended tension rods over the existing drum rim with washers and spacers becoming a permanent part of the drum.

3) The last method is by way of a molded hoop configuration of the drum rim that replaces the original drum rim as a permanent part of the drum.

1) The First method of attachment is by way of a rim extension adjoined of two twelve point sockets that fit onto two drum lugs and are tightened by two 6 mm key screws secured by the tightness of the sockets onto the existing drum rim.

2) As dependant on claim number one, the next method of attachment is by way of a rim extension that fits onto the existing rim with two extended replacement tension rods, washers and spacers to be used as a permanent add on for the drum.

3) As dependant on claim number one, the last method of attachment is by way of a molded hoop configuration that fits permanently in place of the original drum hoop or a permanent add on.
